(19) United States
(12) Patent Application Publication
(10) Pub. No.: US 2025/0316760 A1
(43) Pub. Date: Oct. 9, 2025

(54) ELECTROLYTE FOR LITHIUM SECONDARY BATTERY AND LITHIUM SECONDARY BATTERY INCLUDING THE SAME

(71) Applicant: SK ON CO., LTD., Seoul (KR)

(72) Inventors: Min Young LEE, Daejeon (KR); Min Woo PARK, Daejeon (KR); In Haeng CHO, Daejeon (KR)

(21) Appl. No.: 19/170,070

(22) Filed: Apr. 4, 2025

(30) Foreign Application Priority Data
Apr. 8, 2024 (KR) 10-2024-0047162

(51) Int. Cl. H01M 10/0567; H01M 10/052; H01M 10/0569

(52) U.S. Cl. CPC H01M 10/0567; H01M 10/052; H01M 10/0569; H01M 2300/0037; H01M 2300/0051

(57) ABSTRACT

An electrolyte for a lithium secondary battery according to exemplary embodiments may include an organic solvent, a lithium salt and an additive which includes an alkylene sulfate having 2 to 6 carbon atoms, an alkane sultone having 3 to 6 carbon atoms, and an alkenylene carbonate having 3 to 6 carbon atoms. Accordingly, the lithium secondary battery may suppress an increase in the thickness and resistance under high-temperature environments, and may exhibit improved capacity retention and capacity recovery rates.

### CROSS-REFERENCE TO RELATED APPLICATION

This patent application claims the priority and benefits of Korean patent application No. 10-2024-0047162, filed on Apr. 8, 2024, the disclosure of which is incorporated herein by reference in its entirety.

### BACKGROUND OF THE INVENTION

### 1. Field of the Invention

The present disclosure relates to an electrolyte for a lithium secondary battery and a lithium secondary battery including the same, and more specifically, to an electrolyte for a lithium secondary battery which includes a solvent and an electrolyte salt, and a lithium secondary battery including the electrolyte.

### 2. Description of the Related Art

A secondary battery is a battery that can be repeatedly charged and discharged, and has been widely applied to portable electronic devices such as a mobile phone, a laptop computer, etc. as a power source thereof.

Among the secondary batteries, a lithium secondary battery has a high operating voltage and a high energy density per unit weight, making it advantageous in terms of charging speed and lightweight design. In this regard, the lithium secondary battery has been actively developed and applied to various industrial fields.

The lithium secondary battery may include: for example, an electrode assembly including a cathode, an anode and a separation membrane interposed between the cathode and the anode; and an electrolyte in which the electrode assembly is impregnated.

The lithium secondary battery may further include, for example, a pouch-type outer case in which the electrode assembly and the electrolyte are housed.

The cathode of the lithium secondary battery may be prepared by, for example, applying a cathode slurry, which includes a cathode active material and a binder, and further includes a conductive material as necessary, to a cathode current collector, followed by drying and pressing the same.

The cathode active material may be a material capable of reversibly intercalating and deintercalating lithium ions. For example, the cathode active material may be a lithium metal oxide including a metal element such as nickel (Ni), cobalt (Co), manganese (Mn) and the like.

Meanwhile, as the applications of lithium secondary batteries have recently expanded, excellent cycle life (lifespan) characteristics, high capacity and operational stability are required. Accordingly, it is necessary to develop a lithium secondary battery that provides uniform output and capacity even during repeated charging and discharging cycles.

### SUMMARY OF THE INVENTION

An object of the present disclosure is to provide an electrolyte for a lithium secondary battery having improved thermal and chemical stabilities.

Another object of the present disclosure is to provide a lithium secondary battery which includes the electrolyte and exhibits improved cycle life characteristics and high-temperature storage characteristics.

The lithium secondary battery including the electrolyte of the present disclosure may be widely applied in green technology fields, such as electric vehicles, battery charging stations, as well as solar power generation, wind power generation, and the like, which use the batteries. In addition, the lithium secondary battery of the present disclosure may be used in eco-friendly electric vehicles, hybrid vehicles, and the like, which are aimed at mitigating climate change by reducing air pollution and greenhouse gas emission.

An electrolyte for a lithium secondary battery according to exemplary embodiments of the present disclosure includes: an organic solvent; a lithium salt; and an additive which includes an alkylene sulfate having 2 to 6 carbon atoms, an alkane sultone having 3 to 6 carbon atoms, and an alkenylene carbonate having 3 to 6 carbon atoms.

In some embodiments, a content of the additive may be 1.5% by weight to 6% by weight based on a total weight of the electrolyte.

In some embodiments, a content of the alkylene sulfate may be 0.5% by weight to 2.5% by weight based on the total weight of the electrolyte.

In some embodiments, a content of the alkane sultone may be 0.5% by weight to 2% by weight based on the total weight of the electrolyte.

In some embodiments, a content of the alkenylene carbonate may be 0.5% by weight to 1.5% by weight based on the total weight of the electrolyte.

In some embodiments, a ratio of the content of the alkane sultone to the content of the alkylene sulfate may be 0.2 to 4.

In some embodiments, a ratio of the content of the alkenylene carbonate to the content of the alkylene sulfate may be 0.2 to 3.

In some embodiments, a ratio of the content of the alkenylene carbonate to the content of the alkane sultone may be 0.25 to 3.

In some embodiments, the additive may include ethylene sulfate, propane sultone and vinylene carbonate.

In some embodiments, the additive may consist of ethylene sulfate, propane sultone and vinylene carbonate.

In some embodiments, the organic solvent may include a linear ester solvent and a cyclic carbonate solvent.

In some embodiments, the linear ester solvent may include at least one selected from the group consisting of methyl acetate, ethyl acetate, n-propyl acetate, 1,1-dimethylethyl acetate, methyl propionate, ethyl propionate, propyl propionate and butyl propionate.

In some embodiments, the cyclic carbonate solvent may include at least one selected from the group consisting of ethylene carbonate, propylene carbonate and butylene carbonate.

In some embodiments, the organic solvent may consist of ethyl propionate and ethylene carbonate.

A lithium secondary battery according to exemplary embodiments of the present disclosure includes: an electrode assembly which includes repeatedly stacked cathodes and anodes; and the electrolyte for a lithium secondary battery according to the embodiments of the present disclosure, in which the electrode assembly is impregnated.

When using the electrolyte for a lithium secondary battery according to exemplary embodiments, a swelling phenomenon caused during the charging and discharging of the lithium secondary battery may be effectively prevented, and an amount of heat generated by the electrolyte may be reduced.

The lithium secondary battery according to exemplary embodiments may include the electrolyte for a lithium secondary battery. Accordingly, the lithium secondary battery may exhibit improved capacity retention rate and cycle life characteristics while suppressing an increase in the thickness under high-temperature environments.

### BRIEF DESCRIPTION OF THE DRAWINGS

FIG. 1 is a plan view schematically illustrating a lithium secondary battery according to exemplary embodiments; and

FIG. 2 is a cross-sectional view schematically illustrating the lithium secondary battery according to exemplary embodiments.

### DETAILED DESCRIPTION OF THE INVENTION

An electrolyte for a lithium secondary battery according to exemplary embodiments includes an organic solvent, a lithium salt and an additive having a combination of specific components.

In addition, a lithium secondary battery according to exemplary embodiments includes an electrode assembly including repeatedly stacked cathodes and anodes; and an electrolyte for a lithium secondary battery, in which the electrode assembly is impregnated.

Accordingly, the high-temperature storage characteristics and cycle life characteristics of the lithium secondary battery may be improved.

Hereinafter, embodiments of the present disclosure will be described in more detail with reference to specific implementation examples and drawings. However, the embodiments are merely illustrative and the present disclosure is not limited to the specific embodiments described by way of example.

### <Electrolyte for a Lithium Secondary Battery>

The electrolyte for a lithium secondary battery according to exemplary embodiments (hereinafter, abbreviated as an electrolyte) may include an organic solvent, a lithium salt and an additive.

In some embodiments, the additive may include a carbonate compound, a sultone compound and a sulfate compound.

In some embodiments, the additive may include an alkylene sulfate having 2 to 6 carbon atoms, an alkane sultone having 3 to 6 carbon atoms, and an alkenylene carbonate having 3 to 6 carbon atoms.

For example, the sulfate compound may include an alkylene sulfate having 2 to 5 carbon atoms, an alkylene sulfate having 2 to 4 carbon atoms, an alkylene sulfate having 2 to 3 carbon atoms or ethylene sulfate.

For example, the sultone compound may be an alkane sultone having 3 to 5 carbon atoms, an alkane sultone having 3 to 4 carbon atoms or 1,3-propane sultone.

For example, the carbonate compound may be an alkenylene carbonate having 3 to 5 carbon atoms, an alkenylene carbonate having 3 to 4 carbon atoms or a vinylene carbonate. The number of carbon atoms in the alkenylene carbonate may be calculated by including the carbon atoms contained in the carbonate group.

In one embodiment, the alkenylene carbonate may have a 5-membered to 8-membered cyclic structure, a 5-membered to 7-membered cyclic structure, a 5-membered to 6-membered cyclic structure, or a 5-membered cyclic structure.

In some embodiments, the carbonate compound may include at least one selected from the group consisting of a linear carbonate compound and a cyclic carbonate compound.

For example, the linear carbonate compound may include at least one selected from the group consisting of dimethyl carbonate (DMC), ethyl methyl carbonate (EMC), diethyl carbonate (DEC), methyl propyl carbonate, ethyl propyl carbonate and dipropyl carbonate.

For example, the cyclic carbonate compound may include at least one selected from the group consisting of ethylene carbonate (EC), propylene carbonate (PC), butylene carbonate, pentylene carbonate and vinylene carbonate.

In some embodiments, the sultone compound may include an alkyl sultone compound.

For example, the alkyl sultone compound may include at least one selected from the group consisting of 1,3-propane sultone (PS) and 1,4-butane sultone.

In some embodiments, the sulfate compound may include a cyclic sulfate compound having a cyclic structure. The cyclic sulfate compound may have a 5-membered to 7-membered cyclic structure.

For example, the cyclic sulfate compound may include at least one selected from the group consisting of 1,2-ethylene sulfate (ESA), trimethylene sulfate (TMS), 1,2-propylene sulfate and methyltrimethylene sulfate (MTMS).

In some embodiments, the additive may further include at least one selected from the group consisting of a borate compound, a nitrile compound, an amine compound, a silane compound and a benzene compound.

For example, the borate compound may include at least one selected from the group consisting of lithium tetraphenyl borate and lithium difluoro(oxalato)borate (LiODFB).

For example, the nitrile compound may include at least one selected from the group consisting of succinonitrile, adiponitrile, acetonitrile, propionitrile, butyronitrile, valeronitrile, caprylonitrile, heptanenitrile, cyclopentane carbonitrile, cyclohexane carbonitrile, 2-fluorobenzonitrile, 4-fluorobenzonitrile, difluorobenzonitrile, trifluorobenzonitrile, phenylacetonitrile, 2-fluorophenylacetonitrile and 4-fluorophenylacetonitrile.

For example, the amine compound may include at least one selected from the group consisting of triethanolamine and ethylenediamine fluorophenylacetonitrile.

The silane compound may include, for example, tetravinyl silane, etc.

For example, the benzene compound may include at least one selected from the group consisting of monofluorobenzene, difluorobenzene, trifluorobenzene and tetrafluorobenzene.

In some embodiments, the additive may include ethylene sulfate, propane sultone and vinylene carbonate. When the above-described additives are used in combination, a lithium secondary battery having improved high-temperature storage characteristics and cycle life characteristics of the battery may be efficiently implemented.

In some embodiments, the additive may not include a fluorine-containing carbonate compound and an alkenyl sultone compound. Accordingly, a lithium secondary battery in which an increase in the thickness and an increase in the resistance are suppressed under high-temperature environments may be provided.

For example, the fluorine-containing carbonate compound may include at least one selected from the group consisting of fluoroethylene carbonate (FEC), fluoromethyl methyl carbonate, difluoroethylene carbonate and bis-(fluoromethyl) carbonate.

For example, the alkenyl sultone compound may include at least one selected from the group consisting of ethene sultone, 1,3-propene sultone (PRS), 1,4-butene sultone and 1-methyl-1,3-propene sultone.

In some embodiments, the additive may consist of ethylene sulfate, propane sultone and vinylene carbonate. When an additive consisting of the three compounds is used, the high-temperature storage characteristics and cycle life characteristics of the lithium secondary battery may be further improved.

In some embodiments, a content of the additive may be 1.5% by weight (“wt %”) to 6 wt % based on a total weight of the electrolyte.

For example, the content of the additive may be 1.5 wt % to 5.5 wt %, 1.5 wt % to 5 wt %, 1.75 wt % to 4.75 wt %, 2 wt % to 4.5 wt %, or 2 wt % to 4 wt % based on the total weight of the electrolyte. Within the above range, the high-temperature storage characteristics of the lithium secondary battery may be further improved without inhibiting the migration of lithium ions in the electrolyte.

In some embodiments, a content of the alkylene sulfate may be 0.5 wt % to 2.5 wt % based on the total weight of the electrolyte.

For example, the content of the alkylene sulfate may be 0.5 wt % to 2 wt %, 1 wt % to 2 wt %, 0.5 wt % to 1.5 wt %, or 1 wt % to 1.5 wt % based on the total weight of the electrolyte. Within the above range, an increase in the thickness and an increase in the resistance of the lithium secondary battery may be further suppressed.

In some embodiments, a content of the alkane sultone may be 0.5 wt % to 2 wt % based on the total weight of the electrolyte.

For example, the content of the alkane sultone may be 0.75 wt % to 2 wt %, 1 wt % to 2 wt %, 1.25 wt % to 2 wt %, or 1.5 wt % to 2 wt % based on the total weight of the electrolyte. Within the above range, the high-temperature storage characteristics and capacity retention rate of the lithium secondary battery may be further improved.

In some embodiments, a content of the alkenylene carbonate may be 0.5 wt % to 1.5 wt % based on the total weight of the electrolyte.

For example, the content of the alkenylene carbonate may be 0.75 wt % to 1.5 wt %, 0.5 wt % to 1.25 wt %, 1 wt % to 1.5 wt %, or 0.5 wt % to 1 wt % based on the total weight of the electrolyte. Within the above range, the high-temperature storage characteristics and cycle life characteristics of the lithium secondary battery may be further improved.

In some embodiments, a ratio of the content of the alkane sultone to the content of the alkylene sulfate may be 0.2 to 4, for example, 0.5 to 3.5, 1 to 3, 1.25 to 2.5, or 1.5 to 2.5. Within the above range, an increase in the thickness and an increase in the resistance of the lithium secondary battery may be further suppressed.

In some embodiments, the ratio of the content of the alkenylene carbonate to the content of the alkylene sulfate may be 0.2 to 3, and for example, the ratio may be 0.3 to 2.5, 0.4 to 2, 0.5 to 1.5, 0.5 to 1, or 1 to 1.5. Within the above range, the high-temperature storage characteristics and cycle life characteristics of the lithium secondary battery may be further improved.

In some embodiments, a ratio of the content of the alkenylene carbonate to the content of the alkane sultone may be 0.25 to 3, and for example, the ratio may be 0.3 to 2.5, 0.4 to 2, 0.5 to 1.5, 0.3 to 1, or 0.4 to 1.5. Within the above range, the high-temperature storage characteristics and capacity retention rate of the lithium secondary battery may be further improved.

For example, the organic solvent may include an organic compound which has sufficient solubility for the lithium salt and the additive, and is electrochemically stable without exhibiting reactivity in the secondary battery.

In some embodiments, the organic solvent may include at least one selected from the group consisting of a carbonate solvent, an ester solvent, an ether solvent, a ketone solvent, an alcohol solvent and an aprotic solvent.

In some embodiments, the organic solvent may include a carbonate solvent, and the carbonate solvent may include a cyclic carbonate solvent.

For example, the cyclic carbonate solvent may include at least one selected from the group consisting of ethylene carbonate (EC), propylene carbonate (PC) and butylene carbonate.

In some embodiments, the organic solvent may include an ester solvent, and the ester solvent may include a linear ester solvent and a cyclic ester solvent.

For example, the linear ester solvent may include at least one selected from the group consisting of methyl acetate (MA), ethyl acetate (EA), n-propyl acetate (n-PA), 1,1-dimethylethyl acetate (DMEA), methyl propionate (MP), ethyl propionate (EP), propyl propionate (PP) and butyl propionate (BP).

For example, the cyclic ester solvent may include at least one of γ-butyrolactone (GBL), decanolide, valerolactone, mevalonolactone and caprolactone.

For example, the ether solvent may include at least one of dibutyl ether, tetraethylene glycol dimethyl ether (TEGDME), diethylene glycol dimethyl ether (DEGDME), dimethoxyethane, tetrahydrofuran (THF) and 2-methyltetrahydrofuran.

For example, the ketone solvent may include cyclohexanone, etc.

For example, the alcohol solvent may include at least one of ethyl alcohol and isopropyl alcohol.

For example, the aprotic solvent may include at least one of a nitrile solvent, an amide solvent (e.g., dimethylformamide), a dioxolane solvent (e.g., 1,3-dioxolane) and a sulfolane solvent.

In some embodiments, the organic solvent may include a linear ester solvent and a cyclic carbonate solvent. When the above-described organic solvents are used in combination, a lithium secondary battery having improved high-temperature storage characteristics and cycle life characteristics of the battery may be efficiently implemented.

In some embodiments, the organic solvent may not include a linear carbonate solvent. Accordingly, it is possible to provide a lithium secondary battery in which an increase in the thickness and an increase in the resistance are suppressed under high-temperature environments, and the capacity retention rate is further improved.

For example, the linear carbonate solvent may include dimethyl carbonate, ethyl methyl carbonate, diethyl carbonate, methyl propyl carbonate, ethyl propyl carbonate, dipropyl carbonate, etc.

In some embodiments, the organic solvent may include a larger amount of the linear ester solvent than the cyclic carbonate solvent based on the volume.

In some embodiments, a ratio of the volume of the cyclic carbonate solvent to the volume of the linear ester solvent in the organic solvent may be 1/9 to 1. For example, the ratio may be 1/9 to 3/4, 1/9 to 2/3, 1/6 to 2/3, or 1/4 to 2/3. Within the above range, the high-temperature storage characteristics of the lithium secondary battery may be further improved.

In some embodiments, the organic solvent may consist of a cyclic carbonate solvent and a linear ester solvent. For example, the organic solvent may consist of ethyl propionate and ethylene carbonate. When an organic solvent consisting of the two solvents is used, the high-temperature storage characteristics and cycle life characteristics of the lithium secondary battery may be further improved.

For example, the lithium salt may be represented by Li⁺X⁻.

For example, an anion (X⁻) of the lithium salt may be at least one selected from the group consisting of F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)₂N⁻.

In some embodiments, the lithium salt may include at least one selected from the group consisting of LiBF₄ and LiPF₆.

In some embodiments, the lithium salt may be present in the organic solvent at a concentration of 0.01 M to 5 M, 0.01 M to 4 M, 0.5 M to 3 M, or 0.5 M to 2 M. Within the above concentration range, lithium ions and/or electrons may migrate smoothly during the charging and discharging of the lithium secondary battery.

### <Lithium Secondary Battery>

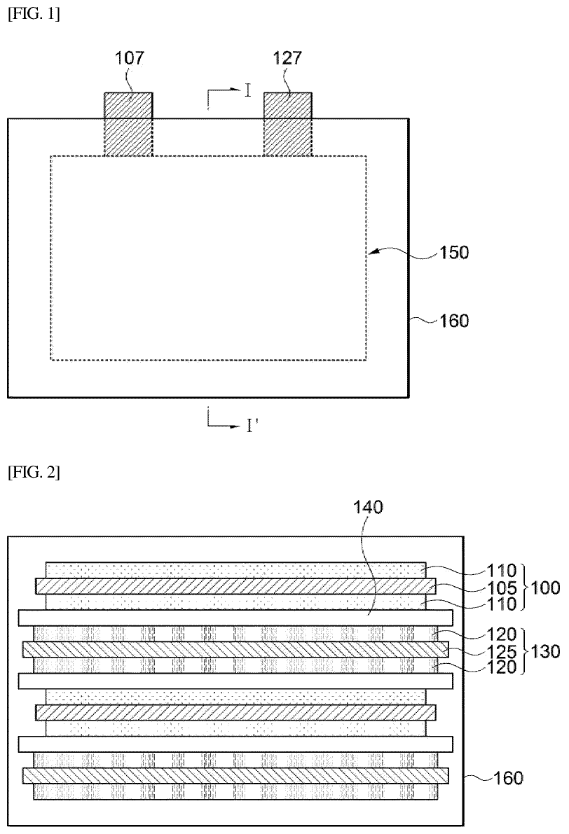

FIGS. 1 and 2 are a schematic plan view and a cross-sectional view illustrating a lithium secondary battery according to exemplary embodiments, respectively. For example, FIG. 2 is a cross-sectional view taken on line I-I′ in FIG. 1.

Referring to FIGS. 1 and 2, the lithium secondary battery may include an electrode assembly 150 including a cathode 100, an anode 130 and a separation membrane 140 interposed between the cathode and the anode.

For example, the electrode assembly 150 may include the cathodes 100 and the anodes 130, which are repeatedly stacked, and the electrode assembly 150 may be housed in a case 160 together with the electrolyte according to the above-described exemplary embodiments to be impregnated therein.

The cathode 100 may include a cathode current collector 105 and a cathode active material layer 110 on the cathode current collector 105.

For example, the cathode active material layer 110 includes a cathode active material and a binder, and may further include a conductive material.

For example, the cathode 100 may be prepared by mixing and stirring the cathode active material, a cathode binder, the conductive material, and a dispersant etc. in a solvent to prepare a cathode slurry, and then applying it to the cathode current collector 105, followed by drying and pressing the same.

The coating process may be performed using methods such as gravure coating, slot die coating, simultaneous multilayer die coating, imprinting, doctor blade coating, dip coating, bar coating or casting, but it is not limited thereto.

For example, the cathode current collector 105 may include stainless steel, nickel, aluminum, titanium, copper, or an alloy thereof. The cathode current collector may also include aluminum or stainless steel subjected to surface treatment with carbon, nickel, titanium, or silver. The cathode current collector may have a thickness of 10 μm to 50 μm, for example, but it is not limited thereto.

For example, the cathode active material may include a material capable of reversibly intercalating and deintercalating lithium ions.

For example, the cathode active material may include a lithium metal oxide containing a metal element such as nickel, cobalt, manganese, or aluminum.

For example, the lithium metal oxide may be represented by Formula 1 below.

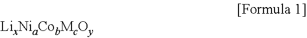

In Formula 1 above, M is at least one of Al, Zr, Ti, Cr, B, Mg, Mn, Ba, Si, Y, W and Sr, and x, y, a, c and b may satisfy 0.9≤x≤1.2, 1.9≤y≤2.1, 0.5≤a≤1, 0≤c/(a+b)≤0.13.

For example, in Formula 1 above, c may be in a range of 0≤c≤0.11.

In some embodiments, in the lithium metal oxide, a content of nickel among elements excluding lithium and oxygen may be 60 mol % or more, 70 mol % or more, 80 mol % or more, 83 mol % or more, or 85 mol % or more.

For example, in Formula 1 above, a may be in a range of 0.6≤a≤1 or 0.8≤a≤1.

In some embodiments, the lithium metal oxide may further include a coating element or a doping element. For example, the coating element or the doping element may include Al, Ti, Ba, Zr, Si, B, Mg, P, Sr, W, La, or an alloy thereof, or an oxide thereof. These may be used alone or in combination of two or more thereof. The lithium metal oxide may be passivated by the coating element or the doping element, thereby further improving stability and cycle life against penetration of an external object.

For example, when the content of nickel in the lithium metal oxide increases, its chemical stability (e.g., high-temperature storage characteristics) may relatively deteriorate. However, in the case of the lithium secondary battery according to the exemplary embodiments, by including the above-described electrolyte, it is possible to provide improved high-temperature storage characteristics even when a high-nickel lithium metal oxide (containing 80 mol % or more of nickel) is used.

For example, the cathode binder may include: an organic binder such as polyvinylidene fluoride (PVDF), vinylidene fluoride-hexafluoropropylene copolymer (PVDF-co-HFP), polyacrylonitrile, polymethyl methacrylate, etc.; an aqueous binder such as styrene-butadiene rubber (SBR), etc. In addition, the cathode binder may be used together with a thickener such as carboxymethyl cellulose (CMC).

For example, the conductive material may include a carbon-based conductive material such as graphite, carbon black, graphene, carbon nanotubes, etc.; a metal-based conductive material such as tin, tin oxide, titanium oxide, or a perovskite material such as LaSiCoO₃, LaSrMnO₃, etc.

The anode 130 may include an anode current collector 125 and an anode active material layer 120 on the anode current collector 125.

For example, the anode active material layer 120 includes an anode active material and an anode binder, and may further include a conductive material.

For example, the anode 130 may be prepared by mixing and stirring the anode active material, the anode binder, the conductive material, etc. in a solvent to prepare an anode slurry, and then applying the anode slurry to the anode current collector 125, followed by drying and pressing the same.

The coating process may be performed using methods such as gravure coating, slot die coating, simultaneous multilayer die coating, imprinting, doctor blade coating, dip coating, bar coating or casting, but it is not limited thereto.

For example, the anode current collector 125 may include gold, stainless steel, nickel, aluminum, titanium, copper, or an alloy thereof, and may include copper or a copper alloy as an example. The anode current collector may have a thickness of, for example, 10 μm to 50 μm, but it is not limited thereto.

For example, the anode active material may be a material capable of intercalating and deintercalating lithium ions. For example, the anode active material may include a carbon-based material such as crystalline carbon, amorphous carbon, carbon composite, or carbon fiber, etc.; a silicone-based material; a lithium alloy and the like.

For example, the amorphous carbon may include hard carbon, cokes, mesocarbon microbead (MCMB) calcined at 1500° C. or lower, mesophase pitch-based carbon fiber (MPCF) or the like. For example, the crystalline carbon may include natural graphite, artificial graphite, graphite cokes, graphite MCMB, graphite MPCF or the like.

For example, the silicon material may include Si, SiOₓ (0<x<2), Si/C, SiO/C, Si-metal or the like.

For example, the lithium alloy may include elements such as aluminum, zinc, bismuth, cadmium, antimony, silicon, lead, tin, gallium, indium or the like.

The anode binder and the conductive material may be substantially the same as or similar to the above-described cathode binder and the conductive material. The anode binder may be, for example, an aqueous binder such as styrene-butadiene rubber (SBR) to ensure compatibility with a carbon-based active material, and may be used together with a thickener such as carboxymethyl cellulose (CMC).

In one embodiment, the separation membrane 140 may be interposed between the cathode 100 and the anode 130. The separation membrane may prevent electrical short-circuit between the cathode and the anode, and maintain flow of ions. According to an embodiment, the separation membrane may have a thickness of 10 μm to 20 μm, but in the present disclosure, it is not limited thereto.

In some embodiments, the anode 130 may have an area (e.g., a contact area with the separation membrane 140) larger than that of the cathode 100. Thereby, lithium ions generated from the cathode 100 may smoothly migrate to the anode 130 without being precipitated during the process.

For example, the separation membrane 140 may include a porous polymer film made of a polyolefin polymer, such as an ethylene polymer, a propylene polymer, an ethylene/butene copolymer, an ethylene/hexene copolymer, and an ethylene/methacrylate copolymer, etc.

For example, the separation membrane 140 may include a nonwoven fabric formed of glass fibers having a high melting point, polyethylene terephthalate fibers and the like.

For example, an electrode cell may be formed by including the cathode 100, the anode 130 and the separation membrane 140. In addition, a plurality of electrode cells may be stacked to form the electrode assembly 150. For example, the electrode assembly 150 may be formed by winding, stacking, z-folding, or stack-folding the separation membrane 140.

The electrode assembly 150 and the above-described electrolyte for a lithium secondary battery may be housed together in the case 160 to form a lithium secondary battery.

As shown in FIG. 1, electrode tabs (a cathode tab and an anode tab) may protrude from the cathode current collector 105 and the anode current collector 125, respectively, which belong to each electrode cell, and may extend to one side of the case 160. The electrode tabs may be fused together with the one side of the case to form electrode leads (a cathode lead 107 and an anode lead 127) extending or exposed to the outside of the case 160.

The lithium secondary battery may be manufactured, for example, in a cylindrical shape using a can, a prismatic shape, a pouch-type shape or a coin shape.

Hereinafter, embodiments of the present invention will be further described with reference to specific experimental examples. However, the following examples and comparative examples included in the experimental examples are only given for illustrating the present invention and those skilled in the art will obviously understand that various alterations and modifications are possible within the scope and spirit of the present invention. Such alterations and modifications are duly included in the appended claims.

### EXAMPLES AND COMPARATIVE EXAMPLES

### (1) Preparation of Electrolyte

A 1.2 M LiPF₆ solution (a mixed solvent of ethylene carbonate (EC)/ethyl propionate (EP) in a volume ratio of 25:75) was prepared.

Based on the total weight (100 wt %) of the electrolyte, 1 wt % of 1,2-ethylene sulfate (ESA), 2 wt % of 1,3-propane sultone (PS), and 1 wt % of vinylene carbonate (VC) were added to the LiPF₆ solution and mixed to prepare an electrolyte of Example 1.

In addition, electrolytes of examples and comparative examples were prepared by modifying the composition of the organic solvent or the composition of the additive, as shown in Table 1 below.

### (2) Manufacture of Lithium Secondary Battery Sample

A cathode slurry was prepared by mixing and dispersing a cathode active material, in which Li[Ni_{0.6}Co_{0.2}Mn_{0.2}]O₂ and Li[Ni_{0.5}Co_{0.1}Mn_{0.1}]O₂ were mixed in a weight ratio of 6:4, carbon black as a conductive material, and polyvinylidene fluoride (PVdF) as a binder in a weight ratio of 92:5:3, in N-methyl-2-pyrrolidone (NMP).

The cathode slurry was uniformly applied to a region of an aluminum foil (thickness: 15 μm) having a protrusion part (cathode tab) on one side except for the protrusion part, followed by drying and pressing the same to prepare a cathode.

An anode slurry was prepared by mixing an anode active material in which artificial graphite and natural graphite were mixed in a weight ratio of 7:3, styrene-butadiene rubber (SBR) as a binder, and carboxymethyl cellulose (CMC) as a thickener in a weight ratio of 97:1:2, in distilled water.

The anode slurry was uniformly applied to a copper foil (thickness: 15 μm) having a protrusion part (anode tab) on one side, except for the protrusion part, followed by drying and pressing the same to prepare an anode.

An electrode assembly was formed by interposing a polyethylene separation membrane (thickness: 20 μm) between the cathode and the anode. Next, a cathode lead and an anode lead were welded and connected to the cathode tab and the anode tab, respectively.

The electrode assembly was housed in a pouch (case) so that some regions of the cathode lead and the anode lead were exposed to an outside of the pouch, followed by sealing three sides of the pouch except for a side of an electrolyte injection part.

After injecting the electrolyte prepared in the above (1) and sealing the side of the electrolyte injection part, a lithium secondary battery was manufactured by impregnation for 12 hours.

TABLE 1

| | Organic solvent | Additive (wt %) | | | | |
|---|---|---|---|---|---|---|
| | (volume ratio) | ESA | PS | VC | FEC | PRS |
| Example 1 | EC:EP (25:75) | 1 | 2 | 1 | — | — |
| Example 2 | EC:EP (25:75) | 1.5 | 1 | 1 | — | — |
| Example 3 | EC:EP (25:75) | 2 | 1 | 1.5 | — | — |
| Example 4 | EC:EP (25:75) | 1 | 0.5 | 1 | — | — |
| Example 5 | EC:EP (25:75) | 0.5 | 0.5 | 0.5 | — | — |
| Example 6 | EC:EP (25:75) | 2.5 | 2 | 1.5 | — | — |
| Example 7 | EC:EMC(25:75) | 1 | 2 | 1 | — | — |
| Example 8 | EC:EP (25:75) | 1 | 2 | 1 | 1 | — |
| Example 9 | EC:EP (25:75) | 1 | 2 | 1 | — | 1 |
| Comparative | EC:EP (25:75) | — | 2 | 1 | — | — |
| Example 1 | | | | | | |
| Comparative | EC:EP (25:75) | 1 | 2 | — | — | — |
| Example 2 | | | | | | |
| Comparative | EC:EP (25:75) | 1 | — | 1 | — | — |
| Example 3 | | | | | | |

The components described in Table 1 are as follows:
EC: Ethylene carbonate
EP: Ethyl propionate
EMC: Ethyl methyl carbonate
ESA: 1,2-ethylene sulfate
PS: 1,3-Propane sultone
VC: Vinylene carbonate
FEC: Fluoroethylene carbonate
PRS: 1,3-Propane sultone

### EXPERIMENTAL EXAMPLE

### Experimental Example 1: Evaluation of Initial Performance (at Room Temperature, 25° C.)

### (1) Evaluation of Initial Capacity (at Room Temperature, 25° C.)

The lithium secondary batteries of the examples and comparative examples were charged at 0.5C-rate CC/CV (4.2V, 0.05C cut-off), and then discharged at 0.5C-rate CC (2.7V cut-off) three times, all at 25° C.

The discharge capacity values obtained in the third cycle were defined as the initial capacity of the lithium secondary batteries, and the result values are described in Table 2 below.

### (2) Evaluation of Battery Initial Thickness

The lithium secondary batteries of the examples and comparative examples were charged at 0.5C-rate CC/CV (4.2V 0.05C cut-off), and then the thicknesses of the lithium secondary batteries were measured using a plate thickness measuring device (Mitutoyo, 543-490B).

The measured thicknesses of the lithium secondary batteries are described in Table 2 below.

### (3) Evaluation of Direct Current Internal Resistance (DCIR)

At the 60% state-of-charge (SOC) point, the C-rate was sequentially increased or decreased to 0.2C, 0.5C, 1.0C, 1.5C, 2.0C, 2.5C and 3.0C, and charging and discharging were performed at each corresponding C-rate for 10 seconds. In this state, the terminal voltage points were plotted to construct a linear equation, and the slope of the resulting line was adopted as the DCIR.

The measured DCIR values are described in Table 2.

### Experimental Example 2: Evaluation of High-Temperature Storage Characteristics (at 60° C.)

After “high-temperature storage,” in which the lithium secondary batteries of the examples and comparative examples were kept at 60° C. for 4 weeks under atmospheric exposure conditions using a thermostat, and then additionally left at room temperature for 30 minutes, the following evaluation was conducted.

(1) Evaluation of Battery Thickness after High-Temperature Storage

After the charged lithium secondary batteries of the examples and comparative examples were stored at a high temperature, the thicknesses of the batteries were measured using a plate thickness measuring device (Mitutoyo, 543-490B).

When the initial thickness of the battery measured in (2) of Experimental Example 1 above was defined as A, and the thickness of the battery after high-temperature storage was defined as B, the thickness increase rate of the battery after high-temperature storage was calculated using Equation 1 below, and the results are described in Tables 2 and 3.

$$Thickness increase rate ( \% ) = ( B - A ) / A \times 100 \qquad [ Equation 1 ]$$

(2) Evaluation of Direct Current Internal Resistance (DCIR) after High-Temperature Storage

At the 60% state-of-charge (SOC) point, the C-rate was sequentially increased or decreased to 0.2C, 0.5C, 1.0C, 1.5C, 2.0C, 2.5C and 3.0C, and charging and discharging were performed at each corresponding C-rate for 10 seconds. In this state, the terminal voltage points were plotted to construct a linear equation, and the slope of the resulting line was adopted as the DCIR.

The DCIR values measured after high-temperature storage are described in Tables 2 and 3 below.

(3) Evaluation of Capacity Retention Rate (Ret) after High-Temperature Storage

After the charged lithium secondary batteries of the examples and comparative examples were stored at a high temperature, the batteries were subjected to 0.5C-rate CC discharge (2.7V cut-off), and then the discharge capacity was measured.

The capacity retention rate was calculated as a percentage by dividing the discharge capacity after high-temperature storage by the initial capacity measured in (1) of Experimental Example 1 above.

$$Capacity retention rate ( \% ) = ( Discharge capacity after high - temperature storage / Initial capacity ) \times 100$$

The calculated capacity retention rate values are described in Tables 2 and 3 below.

4) Evaluation of Capacity Recovery Rate (Rec) after High-Temperature Storage

After measuring the capacity retention rate of the lithium secondary batteries of the examples and comparative examples according to the above (3), the batteries were subjected to 0.5C-rate CC/CV charge (4.2V, 0.05C cut-off) and 0.5C-rate CC discharge (2.7V cut-off), and then the discharge capacity was measured.

The capacity recovery rate was calculated as a percentage by dividing the discharge capacity after measuring the capacity retention rate by the initial capacity measured in (1) of the Experimental Example 1.

$$Capacity recovery rate ( \% ) = ( Discharge capacity after capacity retention rate measurement / Initial capacity ) \times 100$$

The calculated capacity recovery rate values are described in Tables 2 and 3 below.

### Experimental Example 3: Evaluation of Cycle Life (at 45° C.)

### (1) Evaluation of Capacity Retention Rate

The lithium secondary batteries of the examples and comparative examples were charged at 1C to 4.2 V at 45° C. and discharged at 1C to 2.75 V. The charging and discharging were repeated 550 times, and the discharge capacity at the 550th cycle was measured.

The capacity retention rate was calculated as a percentage by dividing the discharge capacity at the 550th cycle (“550th discharge capacity”) by the initial capacity measured in (1) of the Experimental Example 1.

$$Capacity retention rate ( \% ) = ( 550 th discharge capacity / Initial capacity ) \times 100$$

The calculated capacity retention rate values are described in Tables 2 and 3 below.

### (2) Evaluation of Internal Resistance

After the evaluation of (1) above, at the 60% state-of-charge (SOC) point, the C-rate was sequentially increased or decreased to 0.2C, 0.5C, 1.0C, 1.5C, 2.0C, 2.5C and 3.0C, and charging and discharging were performed at each corresponding C-rate for 10 seconds. In this state, the terminal voltage points were plotted to construct a linear equation, and the slope of the resulting line was adopted as the DCIR. The measured DCIR values are described in Tables 2 and 3 below.

TABLE 2

| | | Example | | | | | | | | |
|---|---|---|---|---|---|---|---|---|---|---|
| | | 1 | 2 | 3 | 4 | 5 | 6 | 7 | 8 | 9 |
| Initial | Volume (mAh) | 1909 | 1908 | 1907 | 1905 | 1910 | 1898 | 1907 | 1909 | 1882 |
| performance | Thickness (mm) | 5.48 | 5.48 | 5.47 | 5.48 | 5.47 | 5.48 | 5.65 | 5.67 | 5.46 |
| | D_DCIR (mΩ) | 30.4 | 30.4 | 31.1 | 30.3 | 30.1 | 32.3 | 35.3 | 29.8 | 37.0 |
| Storage at | Thickness | 104 | 105 | 106 | 104 | 107 | 102 | 106 | 115 | 117 |
| 60° C. | increase rate | | | | | | | | | |
| (4 weeks) | (%) | | | | | | | | | |
| | DCIR increase | 104 | 106 | 105 | 105 | 106 | 107 | 113 | 106 | 108 |
| | rate (%) | | | | | | | | | |
| | Ret. (%) | 91 | 91 | 91 | 91 | 91 | 91 | 90 | 90 | 90 |
| | Rec. (%) | 94 | 94 | 93 | 94 | 94 | 94 | 94 | 94 | 93 |
| Cycle life | Ret. (%) | 82.3 | 82.2 | 82.8 | 81.8 | 81.3 | 82.4 | 78.4 | 81.2 | 79.8 |
| at 45° C. | C_DCIR (mΩ) | 102 | 104 | 105 | 103 | 104 | 105 | 124 | 116 | 118 |
| (550th | D_DCIR (mΩ) | 104 | 105 | 106 | 105 | 104 | 106 | 135 | 115 | 116 |
| cycle) | | | | | | | | | | |

TABLE 3

| | | Comparative Example | | |
|---|---|---|---|---|
| | | 1 | 2 | 3 |
| Initial | Volume (mAh) | 1915 | 1907 | 1931 |
| performance | Thickness (mm) | 5.41 | 5.49 | 5.52 |
| | D_DCIR (mΩ) | 27.9 | 29.3 | 28.6 |
| Storage | Thickness increase | 115 | 114 | 113 |
| at 60° C. | rate (%) | | | |
| (4 weeks) | DCIR increase | 106 | 110 | 110 |
| | rate (%) | | | |
| | Ret. (%) | 90 | 90 | 89 |
| | Rec. (%) | 94 | 94 | 94 |
| Cycle life at | Ret. (%) | 80.8 | 79.3 | 79.4 |
| 45° C. (550th | C_DCIR (mΩ) | 118 | 120 | 117 |
| cycle) | D_DCIR (mΩ) | 120 | 117 | 115 |

Referring to Table 2 above, in the lithium secondary batteries of the examples, the battery performance was maintained during high-temperature storage, while the amount of gas generated inside the battery was decreased, thereby reducing the thickness increase rate. In addition, the internal resistance of the lithium secondary batteries of the examples during high-temperature charge and discharge did not significantly increase, thereby improving the high-temperature cycle life characteristics.

On the other hand, referring to Table 3 above, in the lithium secondary batteries of the comparative examples including an electrolyte which did not contain one of alkylene sulfate, alkane sultone and alkenylene carbonate, the thickness of the battery increased excessively during high-temperature storage, or the high-temperature cycle life characteristics of the battery were significantly degraded.

### DESCRIPTION OF REFERENCE NUMERALS

100: Cathode
105: Cathode current collector
110: Cathode active material layer
120: Anode active material layer
125: Anode current collector
130: Anode
140: Separation membrane
150: Electrode assembly
160: Case

What is claimed is:

1. An electrolyte for a lithium secondary battery, comprising:
an organic solvent;
a lithium salt; and
an additive which comprises an alkylene sulfate having 2 to 6 carbon atoms, an alkane sultone having 3 to 6 carbon atoms, and an alkenylene carbonate having 3 to 6 carbon atoms.

2. The electrolyte for a lithium secondary battery according to claim 1, wherein a content of the additive is 1.5% by weight to 6% by weight based on a total weight of the electrolyte.

3. The electrolyte for a lithium secondary battery according to claim 1, wherein a content of the alkylene sulfate is 0.5% by weight to 2.5% by weight based on the total weight of the electrolyte.

4. The electrolyte for a lithium secondary battery according to claim 1, wherein a content of the alkane sultone is 0.5% by weight to 2% by weight based on the total weight of the electrolyte.

5. The electrolyte for a lithium secondary battery according to claim 1, wherein a content of the alkenylene carbonate is 0.5% by weight to 1.5% by weight based on the total weight of the electrolyte.

6. The electrolyte for a lithium secondary battery according to claim 1, wherein a ratio of the content of the alkane sultone to the content of the alkylene sulfate is 0.2 to 4.

7. The electrolyte for a lithium secondary battery according to claim 1, wherein a ratio of the content of the alkenylene carbonate to the content of the alkylene sulfate is 0.2 to 3.

8. The electrolyte for a lithium secondary battery according to claim 1, wherein a ratio of the content of the alkenylene carbonate to the content of the alkane sultone is 0.25 to 3.

9. The electrolyte for a lithium secondary battery according to claim 1, wherein the additive comprises ethylene sulfate, propane sultone and vinylene carbonate.

10. The electrolyte for a lithium secondary battery according to claim 1, wherein the additive consists of ethylene sulfate, propane sultone and vinylene carbonate.

11. The electrolyte for a lithium secondary battery according to claim 1, wherein the organic solvent comprises a linear ester solvent and a cyclic carbonate solvent.

12. The electrolyte for a lithium secondary battery according to claim 11, wherein the linear ester solvent comprises at least one selected from the group consisting of methyl acetate, ethyl acetate, n-propyl acetate, 1,1-dimethylethyl acetate, methyl propionate, ethyl propionate, propyl propionate and butyl propionate.

13. The electrolyte for a lithium secondary battery according to claim 11, wherein the cyclic carbonate solvent comprises at least one selected from the group consisting of ethylene carbonate, propylene carbonate and butylene carbonate.

14. The electrolyte for a lithium secondary battery according to claim 11, wherein the organic solvent consists of ethyl propionate and ethylene carbonate.

15. A lithium secondary battery comprising:
an electrode assembly which comprises repeatedly stacked cathodes and anodes; and
the electrolyte for a lithium secondary battery according to claim 1, in which the electrode assembly is impregnated.
